(19) United States
(12) Patent Application Publication
(10) Pub. No.: US 2013/0054188 A1
(43) Pub. Date: Feb. 28, 2013

(54) COMPUTING DEVICE AND METHOD OF MANAGING MEASURING PROGRAMS

(71) Applicants: CHIH-KUANG CHANG, Tu-Cheng (TW); XIN-YUAN WU, Shenzhen City (CN); GEN YANG, Shenzhen City (CN)

(72) Inventors: CHIH-KUANG CHANG, Tu-Cheng (TW); XIN-YUAN WU, Shenzhen City (CN); GEN YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/481,889

(22) Filed: May 28, 2012

(30) Foreign Application Priority Data
Aug. 31, 2011 (CN) 201110254859.1

(51) Int. Cl. G06F 15/00

(52) U.S. Cl. 702/155

(57) ABSTRACT

In a computing device having a computerized method and a non-transitory storage medium, one or more highlighting modes are constructed, each of which defines which sections in a measuring program need to be highlighted. One of the highlighting modes is selected to highlight a measuring program in a particular way. Then, the highlighted measuring program is displayed on a display unit of the computing device.

### BACKGROUND

1. Technical Field

Embodiments of the present disclosure relate to the field of measuring, and particularly to a computing device and a method of managing measuring programs.

2. Description of Related Art

For the purpose of measuring physical dimensions and geometric tolerances of a product with precision and speed, a three-dimensional (3D) measuring equipment is programmed with a measuring program created using a computer. The computer is configured for the 3D measuring equipment, and works in concert with the 3D measuring equipment.

Before or after measurement, measuring engineers need to check program codes or the measuring values in the measuring program. However, the measuring program may contain thousands of program codes, it may be difficult and time-consuming for the measuring engineers to locate the program codes or the measuring values.

### BRIEF DESCRIPTION OF THE DRAWINGS

FIG. 1 is a block diagram of one embodiment of a computing device that includes a measuring program management system.

FIG. 2 illustrates a flowchart of one embodiment of a method for managing a measuring program.

FIGS. 3-5 illustrate highlighted modes of a measuring program.

### DETAILED DESCRIPTION

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

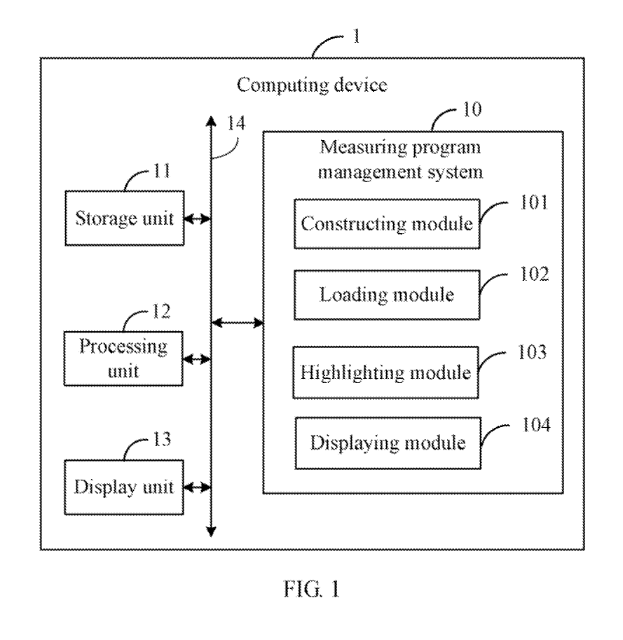

FIG. 1 is a block diagram of one embodiment of a computing device 1 including a measuring program management system 10. The computing device 1 may be a computer, a server, or a personal digital assistant (PDA), for example. The computing device 1 may further include such components as a storage unit 11, a processing unit 12, a display unit 13, and a bus 14. The computing device 1 may be configured in a number of other ways and may include other or different components.

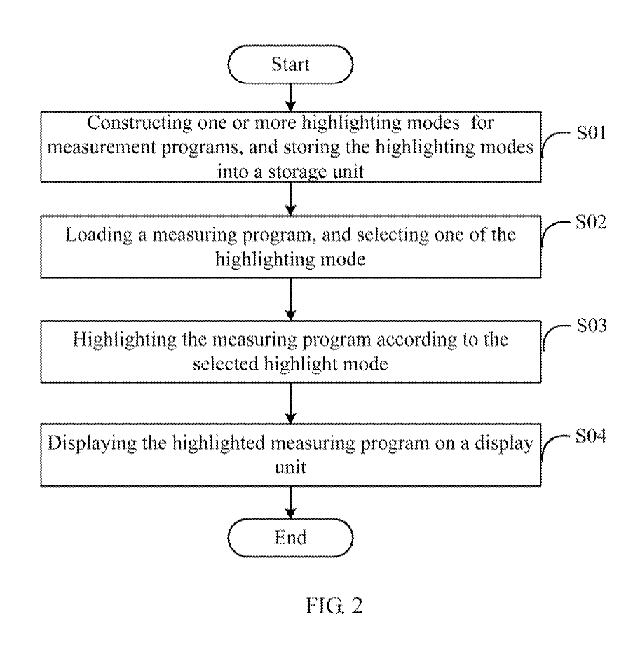

The measuring program management system 10 includes a number of function modules, such as a constructing module 101, a loading module 102, a highlighting module 103, and a displaying module 104. The function modules 101-104 may include computerized code in the form of one or more programs, and at least provide the functions needed to execute the steps illustrated in FIG. 2.

The storage unit 11 may include some type(s) of non-transitory computer-readable storage medium, such as a hard disk drive, a compact disc, a digital video disc, or a tape drive. The storage unit 11 stores the computerized code of the function modules 101˜104 of the measuring program management system 10.

The storage unit 11 also stores one or more measuring programs, and stores information or data needed or generated by the measuring program management system 10.

The processing unit 12 may include a processor, a microprocessor, an application-specific integrated circuit (ASIC), or a field programmable gate array, (FPGA) for example. The processing unit 12 may execute the computerized code of the function modules 101˜104 of the measuring program management system 10 to realize the functions of the measuring program management system 10 as illustrated in FIG. 2.

The display unit 13 may include one or more output mechanisms, including a display, a printer, for example. The display unit 13 can display the one or more measuring programs, and displays data generated by or for the measuring program management system 10, such as one or more highlighted measuring programs.

The bus 14 permits intercommunication among the components, such as between the measuring program management system 10, the storage unit 11, the processing unit 12, and the display unit 13.

FIG. 2 illustrates a flowchart of one embodiment of a method for managing measuring programs. Depending on the embodiment, additional steps may be added, others removed, and the ordering of the steps may be changed.

In step S01, the constructing module 101 constructs one or more highlighting modes for measurement programs, and stores the highlighting modes into the storage unit 11. Each of the highlighting modes defines which sections in a measuring program need to be highlighted. In one embodiment, the highlighting modes may include, for example, a program segments distinction mode, a measuring values highlighting mode, and a revisable codes highlighting mode.

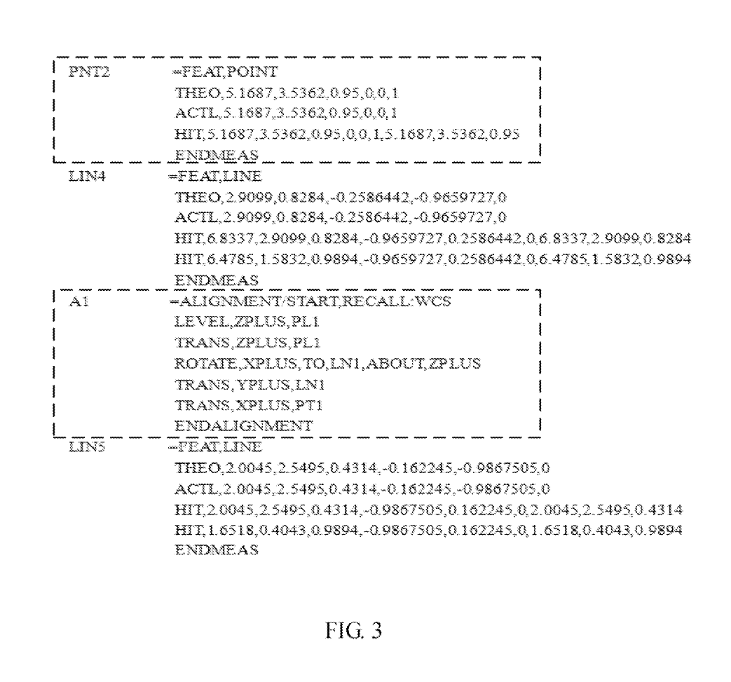

In the program segments distinction mode, two adjacent program segments in a measuring program are distinguished using a method of, such as, one program segment being colored using a first color, and the adjacent program being colored using a second color, or one program segment being highlighted using bold lines, and the adjacent program in standard-weight lines. One example of the program segments distinction mode is illustrated in FIG. 3, where the program segments with the broken lines can be colored using a first color, and others programs segments can be colored using a second color, for example.

In one embodiment, the program segments distinction mode is realized by searching for one or more predefined first keywords in a measuring program. Each of the first keywords indicates an end of a program segment, which may be “ENDMEAS”, or “ENDALIGNMENT”, for example.

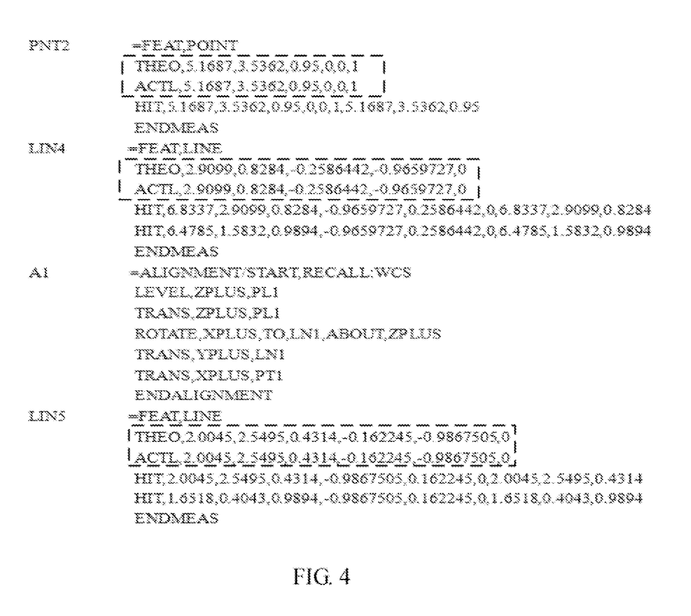

In the measuring values highlighting mode, the measuring values of an object in a measuring program are highlighted by, for example, being colored using a particular color, or by using bold lines. One example of the measuring values highlighting mode is illustrated in FIG. 4, where the program segments with the broken lines can be colored using a particular color, for example.

In one embodiment, the measuring values highlighting mode is realized by searching for one or more predefined second keywords in a measuring program. The second keywords may include, for example “THEO” which indicates theory measuring values, and “ACTL” which indicates actual measuring values.

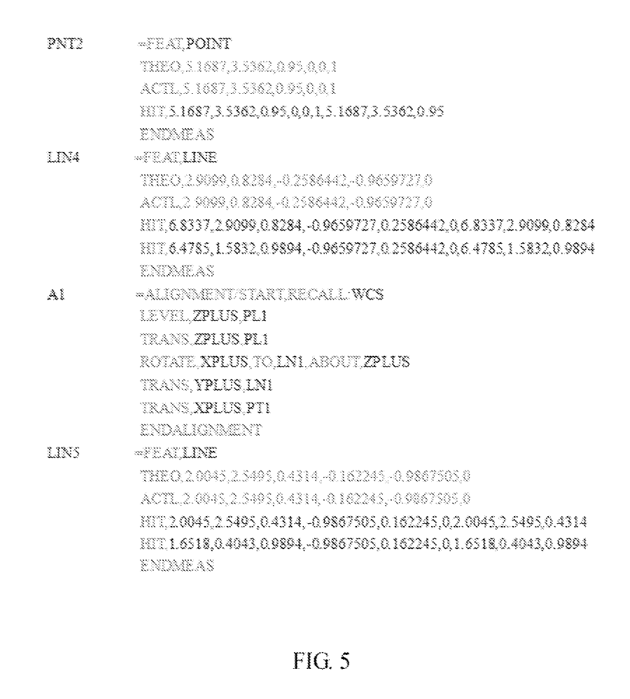

In the revisable codes highlighting mode, the revisable program codes in a measuring program are highlighted by, for example, being colored using a particular color, or by using bold lines. The revisable program codes may include measuring element names, such as “PNT1” which indicates the first or starting point on an object, “LIN 2” which indicates the second line on the object. The revisable program codes may further include a measuring element type, such as “point,” “line,” “cycle,” and “plane.” One example of the revisable codes highlighting mode is illustrated in FIG. 5, where the deep black sections include revisable program codes.

In one embodiment, the revisable codes highlighting mode is realized by searching for one or more predefined third keywords, such as “PNT1” “LIN 2”, or the like, in a measuring program.

In step S02, the loading module 102 loads a measuring program from the storage unit 11, and selects a highlighting mode for the measuring program from the storage unit 11.

In step S03, the highlighting module 103 highlights the measuring program according to the selected highlighting mode. As mentioned above, the highlighting module 103 searches for the first, second, or third keywords, all predefined, from the measuring program and highlights the measuring program according to the keywords.

In step S04, the displaying module 104 displays the highlighted measuring program on the display unit 13.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computerized method for managing measuring programs, the method being executed by at least one processor of a computing device and comprising:
constructing one or more highlighting modes, each of which defines which sections in a measuring program need to be highlighted;
selecting one of the highlighting modes;
highlighting a measuring program according to the selected highlighting mode; and
displaying the highlighted measuring program on a display unit of the computing device.

2. The method according to claim 1, wherein the highlighting modes comprise a program segments distinction mode, a measuring values highlighting mode, and a revisable codes highlighting mode.

3. The method according to claim 2, wherein the program segments distinction mode differentiates two adjacent program segments in the measuring program.

4. The method according to claim 2, wherein the measuring values highlighting mode highlights the measuring values of an object in the measuring program.

5. The method according to claim 2, wherein the revisable codes highlighting mode highlights the revisable program codes in the measuring program.

6. A computing device, comprising:
a display unit;
a non-transitory storage medium, which stores one or more measuring programs;
at least one processor; and
one or more modules that are stored in the non-transitory storage medium; and are executed by the at least one processor, the one or more modules comprising instructions to:
construct one or more highlighting modes, each of which defines which sections in a measuring program need to be highlighted;
select one of the highlighting modes;
highlight a measuring program according to the selected highlighting mode; and
display the highlighted measuring program on the display unit.

7. The computing device according to claim 6, wherein the highlighting modes comprise a program segments distinction mode, a measuring values highlighting mode, and a revisable codes highlighting mode.

8. The computing device according to claim 7, wherein the program segments distinction mode differentiates two adjacent program segments in the measuring program.

9. The computing device according to claim 7, wherein the measuring values highlighting mode highlights the measuring values of an object in the measuring program.

10. The computing device according to claim 7, wherein the revisable codes highlighting mode highlights the revisable program codes in the measuring program.

11. A non-transitory storage medium having stored thereon instructions that, when executed by a processor of a computing device, causes the processor to perform a method for managing measuring programs, comprising:
constructing one or more highlighting modes, each of which defines which sections in a measuring program need to be highlighted;
loading a measuring program from a storage unit of the computing device;
highlighting a measuring program according to the selected highlighting mode; and
displaying the highlighted measuring program on a display unit of the computing device.

12. The non-transitory storage medium according to claim 11, wherein the highlighting modes comprise a program segments distinction mode, a measuring values highlighting mode, and a revisable codes highlighting mode.

13. The non-transitory storage medium according to claim 12, wherein the program segments distinction mode differentiates two adjacent program segments in the measuring program.

14. The non-transitory storage medium according to claim 12, wherein the measuring values highlighting mode highlights the measuring values of an object in the measuring program.

15. The non-transitory storage medium according to claim 12, wherein the revisable codes highlighting mode highlights the revisable program codes in the measuring program.
